(19) United States
(12) Patent Application Publication
(10) Pub. No.: US 2008/0304281 A1
(43) Pub. Date: Dec. 11, 2008

(54) Operating Lumina

(75) Inventor: Manfred Scholz, Seitingen-Oberflacht (DE)

Correspondence Address: LEWIS AND ROCA LLP, 1663 Hwy 395, Suite 201, Minden, NV, 89423, US

(73) Assignee: BERCHTOLD HOLDING GmbH, Tuttlingen (DE)

(21) Appl. No.: 11/997,535

(22) PCT Filed: Aug. 2, 2006
(86) PCT No.: PCT/EP2006/007655

§ 371 Date: Jun. 30, 2008

(30) Foreign Application Priority Data
Aug. 2, 2005 (DE) 10 2005 036 275.3

(51) Int. Cl. F21S 8/00

(52) U.S. Cl. 362/572

(57) ABSTRACT

An operating lumina comprising at least one light source arranged in a lumina body and an optical means for directing the visible radiation from the light source in a main radiating direction onto an operating zone has an additional luminous means that can be switched independently of the light source.

The present invention relates to a surgical lamp having at least one light source arranged in a lamp body and an optical means to direct the visible radiation of the light source in a main radiation direction onto a surgical field.

Surgical lamps of this kind are generally known, with halogen lamps or discharge lamps being used as the light source and reflectors being used as the optical means. In this connection, the visible radiation of the light source is directed in a direction toward the surgical field to be illuminated which is termed the main radiation direction in the following.

It is the object of the invention to provide a surgical lamp with which the performance capability of the surgical team can be increased.

This object is satisfied by the features of claim 1.

In accordance with the invention, the surgical lamp has at least one additional illuminant, for example one or more light emitting diodes, whose intensity maximum is in the region of approximately 450 nm, with a control device being provided with which this additional illuminant can be controlled independently of the light source, that is for example, further light emitting diodes, halogen lamps or discharge lamps. The realization is utilized that light also has a physiological effect on the observer. A second portion of the optic tract is activated by light of a specific wavelength in the blue color spectrum which activates the metabolism and the endocrine glands to rhythmic activity as an energetic portion. It is known that the release of a hormone (melatonin) is inhibited by daylight, which serves for the activation of the circulation since melatonin regulates the day/night rhythm (circadian rhythm). The secretion of melatonin at night is effected by the blue light by photosensors in the human eye which are distributed uniformly over the retina and which cannot resolve an image pattern. Since surgical teams frequently have to work for many hours, and often also at night, under stress at very high concentration, the surgeon can be supported in his work by a suitable selection of the light spectrum such that he can also work at maximum concentration capability during a difficult emergency operation at night. The suppression of the melatonin secretion can be excited by the additional illuminant with an intensity maximum in the range of approximately 450 nm such that the performance capability of the surgical team is increased, even if it has to operate for several hours at night or during the day.

Advantageous embodiments of the invention are described in the description, in the drawing and in the dependent claims.

In accordance with a first advantageous embodiment, the additional illuminant can be switched in automatically by the control device in dependence on specific parameters. Such parameters can, for example, be the current time (time of day) or the current operating duration of the light source from which a conclusion can be drawn on the already past operating time. It is, for example, possible to increase the radiation of the illuminant when the current time is progressing, i.e. when it is increasingly becoming night. An increase can also take place when the light source increasingly remains switched on, i.e. when the operation has, for example, lasted several hours. Fatigue can hereby be prevented, on the one hand, and an increase in performance can even be effected, on the other hand.

In accordance with a further embodiment, the color spectrum of the surgical lamp is additionally controlled such that the desired wavelength range of approximately 450 nm is radiated with increased intensity or increasingly increased intensity.

The additional illuminant for melatonin suppression does not necessarily have to radiate in the main radiation direction in the direction of the surgical field. The radiation can rather also take place to the side or to the top, i.e. indirectly. Furthermore the illuminant can also be arranged in a separate lamp body. When the additional illuminant radiates in a secondary radiation direction which is not directed to the surgical field, the desired effects on the surgical personnel can be optimized since, in this case, the radiation in the range of approximately 450 nm can be directed directly into the eyes of the surgical personnel with the help of the additional light source and thus no attenuation of the light takes place by reflections at the surgical field. Particularly good results can be achieved when the additional illuminant radiates in a secondary radiation direction which extends at an angle of approximately 45 to 135° to the main radiation direction.

In accordance with a further advantageous embodiment, the additional illuminant can also be switched on when the light source is switched off. The desired effects can hereby already be achieved before the surgery when the surgical personnel takes preparatory measures. The effect of the additional illuminant can also take place with endoscopic surgery. If the additional illuminant can be switched off with a switched on light source, the additional illuminant can be conserved when its effect is not required, for example with only short interventions.

In accordance with a further advantageous embodiment, the additional illuminant can be integrated into a handle of the surgical lamp. It is not necessary in this embodiment to change the lamp body for the mounting of the additional illuminant. In addition, the additional illuminant can be arranged in the handle in a simple manner so that it radiates in the direction of the eyes of the surgical personnel. It is particularly advantageous when the additional illuminant has a diffuser since, in this case, the radiation of the additional illuminant can be distributed as best as possible in the operating room and can thus easily reach into the eyes of the surgical personnel.

In accordance with a further advantageous embodiment, the control can have a control output for the control of an external additional illuminant. In this manner, an additional illuminant can be additionally or alternatively provided which is not integrated into the surgical lamp. In this case, a separate light module can be provided as the external additional illuminant or the external additional illuminant can be integrated into a stationary lighting of the operating room.

In accordance with a further aspect of the invention, it relates to a method for the illumination of an operating room, with the radiation of at least one additional illuminant being directed directly in the direction of the eyes of the surgical personnel at least at times.

The present invention will be described in the following with reference to an advantageous embodiment and to the drawing. There are shown:

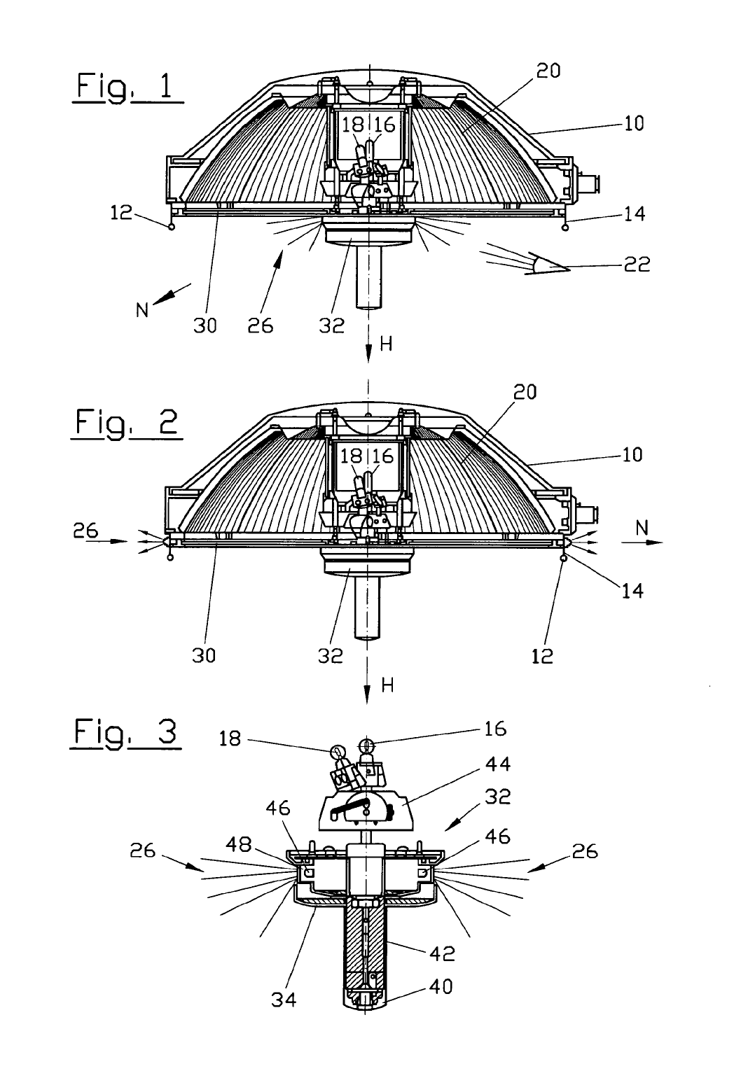

FIG. 1 a partially sectioned side view of a surgical lamp;

FIG. 2 a partially sectioned side view of a further embodiment of a surgical lamp; and

FIG. 3 a magnified representation of the handle of the surgical lamp of FIG. 1.

The surgical lamp shown in FIG. 1 has a lamp body 10 which is made in hood shape and which is surrounded at its outer periphery by a railing 12 which is fastened to the outer side of the lamp body 10 via support elements 14.

A light source is arranged in the interior of the lamp body 10 in the form of two exchangeable halogen lamps 16, 18 which illuminate a surgical field via a parabolic reflector 20. The reflector 20 is made in this respect such that a shadow-free light is output in the main radiation direction marked by the arrow H onto the surgical field.

In the embodiment shown in FIG. 1, an additional illuminant 26 is provided in the interior of the handle 32 in the form of a plurality of light emitting diodes whose intensity maximum is in the region of approximately 450 nm. The bandwidth of the spectrum radiated by the additional illuminant is in the range from approximately 380 to 520 nm. The additional illuminant 16 radiates in a secondary radiation direction marked by N which extends at an angle to the main radiation direction H. In the embodiment shown in FIG. 1, this angle amounts to approximately 70°. The radiation of the additional illuminant 26 is distributed over the total periphery of the handle 32. Optical diffusers which generate a diffuse radiation of the additional illuminant are provided for better light distribution.

As FIG. 1 shows, the radiation of the additional illuminant 26 moves immediately directly into the eye 22 of the surgical personnel in the radiation direction N.

A control device (not shown), with which the additional illuminant can be switched on and off independently of the light source 16, 18, is provided for the control of the additional illuminant 26. This means that the additional illuminant 26 can be switched on when the light source 16, 18 is switched off and can also be switched off when the light source 16, 18 is switched on.

FIG. 3 shows a magnified representation of the handle of the surgical lamp of FIG. 1. In addition to a CCD camera 42 arranged in a shaft 40 of the handle, the handle 32 has a beaker-like mount 34 to whose lower side the shaft 40 is fastened. The mount 34 is open at its upper side and a lamp holder 44 projects from the upper side at which the exchangeable illuminants 16, 18 are fastened. The handle has a setting for the light field diameter in a known manner.

As FIG. 3 shows, a plurality of light emitting diodes 46 are provided in the interior of the beaker-like mount 34 which are distributed over its periphery and form the additional illuminant 26. A respective diffuser lens 48 is arranged in front of the light emitting diodes 46 to generate diffuse radiation.

A transparent end plate 30 is provided at the lower side of the surgical lamp and the handle 32 is arranged at its center. The surgical lamp itself is fastened to a stand or a suspension via joint arms which are not shown.

FIG. 2 shows an alternative embodiment of a surgical lamp, with the same reference numerals being used for the same components.

In the surgical lamp shown in FIG. 2, the additional illuminant 26 is not integrated into the handle 32, but rather into the lamp body 10. In this connection, light emitting diodes are arranged distributed over the periphery of the surgical lamp at its lower side, with the secondary radiation direction N of the additional illuminant extending approximately at 90° to the main radiation direction H in this embodiment. Diffusers are also arranged in front of the light emitting diodes in this embodiment.

In an alternative embodiment, which is not shown, a plurality of light emitting diodes are provided instead of the halogen lamps 16, 18 and radiate in different wavelengths to achieve a desired color mixture.

A control device (not shown) serves for the control of the illuminants of the surgical lamp described above, with the additional illuminant 26 being able to be switched in and off independently of the illuminants 16, 18.

The control is configured such that the conventional operating room light remains unchanged, even when the light emitting diodes required for the radiation of 450 nm radiate at increased intensity. The increase of the radiation in the range of 450 nm (called excitation radiation in the following) can be permanently switched in by a push button. Alternatively, an automatic operation can be triggered with the aid of a further push button in which the excitation radiation is automatically switched in with the help of a preset program in dependence on the current time and/or on the current operating period of the surgical lamp. In this connection, the excitation radiation is constantly increased as the operating time of the surgical lamp increases during an operation and as the time of day progresses further. For this purpose, the control has a built-in clock and a time measuring unit which is activated on the switching on of the surgical lamp such that a conclusion can be drawn on the duration of an operation.

### REFERENCE NUMERAL LIST

10 lamp body
12 railing
14 holder
16, 18 halogen lamps
20 reflector
22 eye
26 additional illuminant
30 transparent plate
32 handle
34 mount
40 shaft
42 electronic camera
44 holder
46 light emitting diodes
48 diffusers
H main radiation direction
N secondary radiation direction

1. A surgical lamp having at least one light source arranged in a lamp body and an optical means to direct the visible radiation of the light source in a main radiation direction onto a surgical field, characterized in that at least one additional illuminant is provided whose intensity maximum is in the region of approximately 450 nm;
and in that a control device is provided with which this additional illuminant can be switched independently of the light source.

2. A surgical lamp in accordance with claim 1, characterized in that the illuminant can be switched on automatically by the control device with reference to at least one parameter which is selected from the following group: current time, and current operating duration of the surgical lamp.

3. A surgical lamp in accordance with claim 1, characterized in that the additional illuminant has a luminous flux that is automatically variable by the control device in dependence on the current operating duration of the surgical lamp.

4. A surgical lamp in accordance with claim 1, characterized in that the additional illuminant radiates in a secondary radiation direction which is not directed to the surgical field.

5. A surgical lamp in accordance with claim 1, characterized in that the additional illuminant radiates in a secondary radiation direction which extends at an angle of approximately 45-135° to the main radiation direction.

6. A surgical lamp in accordance with claim 1, characterized in that the additional illuminant can be switched on when the light source is switched off.

7. A surgical lamp in accordance with claim 1, characterized in that the additional illuminant can be switched off when the light source is switched on.

8. A surgical lamp in accordance with claim 1, characterized in that the additional illuminant is integrated into a handle of the surgical lamp.

9. A surgical lamp in accordance with claim 1, characterized in that the additional illuminant is integrated into the lamp body.

10. A surgical lamp in accordance with claim 1, characterized in that the additional illuminant has a diffuser.

11. A surgical lamp in accordance with claim 1, characterized in that the control has a control output for the control of an external additional illuminant.

12. A surgical lamp in accordance with claim 11, characterized in that the external additional illuminant is a separate light module.

13. A method for the illumination of an operating room, wherein visible radiation of the light source is directed in a main radiation direction onto a surgical field using a surgical lamp having at least one light source arranged in a lamp body and an optical means, characterized in that the radiation of at least one additional illuminant whose intensity maximum is in the region of approximately 450 nm is directed in the direction of the eyes of the surgical personnel at least at times.

14. A method in accordance with claim 13, characterized in that a surgical lamp is used having at least one light source arranged in a lamp body and an optical means to direct the visible radiation of the light source in a main radiation direction onto a surgical field, characterized in that at least one additional illuminant is provided whose intensity maximum is in the region of approximately 450 nm and in that a control device is provided with which this additional illuminant can be switched independently of the light source.

15. A method in accordance with claim 13, characterized in that the additional illuminant is switched on automatically with reference to at least one parameter selected from the following group: current time, and current operating duration of the surgical lamp.

16. A method in accordance with claim 13, characterized in that the additional illuminant has a luminous flux that is automatically varied in dependence on the current operation duration of the surgical lamp.

17. A surgical lamp in accordance with claim 11, characterized in that the external additional illuminant is integrated into a stationary lighting of an operating room.
